(19) United States
(12) Patent Application Publication
(10) Pub. No.: US 2008/0106640 A1
(43) Pub. Date: May 8, 2008

(54) METHOD OF MULTIPLE STREAM FORMATTING IN A MULTIMEDIA SYSTEM

(75) Inventor: Thomas J. Fleischman, Poughkeepsie, NY (US)

Correspondence Address: LAW OFFICE OF DELIO & PETERSON, LLC., 121 WHITNEY AVENUE, NEW HAVEN, CT, 06510, US

(73) Assignee: INTERNATIONAL BUSINESS MACHINES CORPORATION, Armonk, NY (US)

(21) Appl. No.: 11/556,794

(22) Filed: Nov. 6, 2006

(51) Int. Cl. H04N 7/01

(52) U.S. Cl. 348/441

(57) ABSTRACT

A method of multiple stream formatting in a multimedia system. An input media signal is simultaneously converted to a plurality of different media formats selected from a menu, and the different media formats are stored on a storage device. The method then includes retrieving one or more desired different formats of the media signal and transferring the selected format of the media signal to a media device compatible with the selected format. When a media device is connected to the storage device, the method includes identifying a media format used by the media device, and using the identification of the media format used by the media device to select the same media format from the storage device for retrieval and transfer of the selected format of the media signal to the media device.

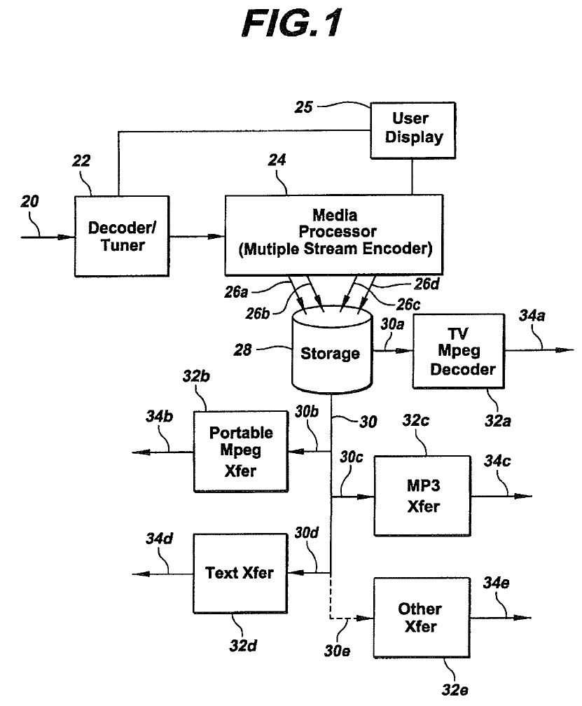

### BACKGROUND OF THE INVENTION

1. Field of the Invention

The present invention relates to conversion and formatting of audio/video media signals and, in particular, to a method and system for simultaneously formatting a media signal into multiple media formats for storage and later use without further format conversion.

2. Description of Related Art

In the past, home media has been limited to a cable box sitting on top of one's television. It would be desirable for the next generation home media to employ or serve as media servers for the whole house, and to utilize high speed network connections and support a greater number of features and protocols such as H.264 and its follow on, video on demand, high end gaming, and the like. In order to do so, it will be necessary for the media servers of tomorrow to be powered by extremely high speed central processing units (CPUs), such as the IBM/SONY Cell processor. The power of these chips has been demonstrated to be able to allow for more than just a simple media data stream converter to allow one to watch a single channel.

One application today for high speed CPUs is receiving and decoding of an analog or digital signal stream to be shown respectively on analog or digital televisions. A number of users of higher end digital television systems desire to record and watch the media signal stream later by recording on digital recorders such as TiVo. Alternatively, users may take the recorded signal and burn it to a DVD and/or other the media storage, such as a portable format for offline viewing like video iPod and the like. This process usually involves multiple steps that are time consuming and not typically user friendly.

In a current straight decode media system, an analog or digital media signal is sent to a decoder/tuner, where it is modified to produce a signal compatible with a standard television monitor. In a modification used with a personal video recorder (PVR), the decoder/tuner output is sent to a Mpeg encoder, for conversion to a desired Mpeg format, and then the program file is stored on a storage device. When the media signal or program is to be viewed, the file is retrieved from storage and decoded to produce the standard television monitor-compatible signal. In a further modification, analog or digital media signal input is sent directly to save the program file on a storage device, from which it is retrieved and decoded to produce the monitor-compatible signal when the program is to be viewed.

A standalone DVD burner typically takes the analog or digital media signal input directly and converts the signal to burn or create the DVD. A networked version may send the analog or digital media signal input to a decoder/tuner, and the output signal is sent to a Mpeg encoder for conversion and then onto the storage device to save the program file. When the DVD is to be created, the stored program file is retrieved from storage and decoded from the Mpeg format to the DVD format on to the DVD burner to create the DVD. This latter method requires time to transfer the file over Ethernet or other network cable and computer time for re-encoding the Mpeg stream into DVD compatible format, then additional burn time onto the DVD. There also exist tools to extract portions of the file, such as audio only, for creation of audio CDs.

Each of the above techniques require extensive hardware and software expenditures, along with time and expertise to enable one to use the media stream in ways other than the initial viewing purpose. Since many today desire to convert to mobile platforms such as iPod, video iPod, and the like, doing so can be difficult and expensive utilizing prior art techniques.

### SUMMARY OF THE INVENTION

Bearing in mind the problems and deficiencies of the prior art, it is therefore an object of the present invention to provide an improved method and system for storing and viewing media signal program files in a plurality of different media formats.

It is another object of the present invention to provide a method and system for formatting a media signal into multiple streams that may be used by different format media viewers.

A further object of the invention is to provide a method and system that enables multiple stream formatting in a multimedia system, and storage of such multiple streams for easy later viewing and listening.

It is yet another object of the present invention to provide a method and system of retrieving a recorded program file and download it to different media player formats without converting the file from one format to another.

Still other objects and advantages of the invention will in part be obvious and will in part be apparent from the specification.

The above and other objects, which will be apparent to those skilled in the art, are achieved in the present invention which is directed to a method of multiple stream formatting in a multimedia system comprising providing an input media signal, converting the media signal to a plurality of different media formats, and storing the converted media signal in the plurality of different media formats on a storage device. The method then includes retrieving one or more desired different formats of the media signal and transferring the selected format of the media signal to a media device compatible with the selected format.

The method preferably simultaneously converts the media signal in parallel to a plurality of different media formats prior to storing the converted media signal in the plurality of different media formats. The method may further include providing a menu of different media formats, selecting a plurality of different media formats from the menu and subsequently converting the media signal to the plurality of selected media formats.

The media signal may be converted to different audio, video or text formats. These may include DV, Divx, Mpeg, Mp3, Wma, and Real formats.

The method may further include connecting a media device to the storage device, and identifying a media format used by the media device, and using the identification of the media format used by the media device to select the same media format from the storage device for retrieval and transfer of the selected format of the media signal to the media device. The method may also include using the desired format of the media signal on the media device without further format conversion.

If more than one media signal is inputted, the method may further include simultaneously converting each of the plurality of media signals to a plurality of different media formats prior to storing the converted media signals in the plurality of different media formats.

In another aspect, the present invention is directed to a system for formatting one or more streams of a media signal comprising a media signal input circuit, a media signal conversion processor for simultaneous parallel conversion of the media signal to plurality of different media formats, and a storage device for storing the converted media signal in the plurality of different media formats. The system also includes a plurality of output circuits connectible to different media devices for retrieving one of the formats of the media signal compatible with a media device and transferring the compatible format of the media signal to the media device.

The system may further include a menu display of different media formats into which the media signal may be converted. The conversion processor may be adapted to convert the media signal into different audio, video or text formats. Such different media formats may include DV, Divx, Mpeg, Mp3, Wma, and Real formats.

The output circuit is preferably adapted to identify the media format used by the media device to which it is connected and use the identification of the media format used by the media device to select the same media format from the storage device for retrieval and transfer of the selected format of the media signal to the media device. The output circuit may be adapted to transfer the selected format of the media signal on the media device without further format conversion.

The media signal conversion processor is preferably adapted to simultaneously converting each of a plurality of media signals to a plurality of different media formats prior to the storage device storing the converted media signals in the plurality of different media formats.

In a further aspect, the present invention is directed to a computer program product for use with a multimedia system for formatting one or more streams of a media signal. The computer program product comprises a computer usable medium having computer readable program code means embodied in said medium for converting the media signal to a plurality of different media formats and computer readable program code means for storing the converted media signal in the plurality of different media formats on a storage device. The product also includes computer readable program code means for retrieving one or more desired different formats of the media signal and computer readable program code means for transferring the selected format of the media signal to a media device compatible with the selected format.

The computer program product preferably includes computer readable program code means for simultaneously converting the media signal in parallel to a plurality of different media formats prior to storing the converted media signal in the plurality of different media formats.

The computer program product may include computer readable program code means for providing a menu of different media formats, selecting one or more different media formats from the menu and subsequently converting the media signal to the plurality of selected media formats. The computer readable program code means may transfer the desired format of the media signal on the media device without further format conversion.

The computer program product may also include computer readable program code means for simultaneously converting each of a plurality of media signals to a plurality of different media formats prior to storing the converted media signals in the plurality of different media formats.

### BRIEF DESCRIPTION OF THE DRAWINGS

The features of the invention believed to be novel and the elements characteristic of the invention are set forth with particularity in the appended claims. The FIGURE is for illustration purposes only and is not drawn to scale. The invention itself, however, both as to organization and method of operation, may best be understood by reference to the detailed description which follows taken in conjunction with the accompanying drawing FIGURE which depicts a schematic of the method and system of the present invention for simultaneously formatting a media signal into multiple media formats for storage and later use without further format conversion.

### DESCRIPTION OF THE PREFERRED EMBODIMENTS

The present invention utilizes the power of the high performance, high speed media processors to enable a user to identify what type of media stream data he or she desires and have the media processor decode and convert the input signal into multiple format streams simultaneously. As used herein, the terms “media signal” and “media stream” refer to audio and/or video signals or data, optionally including text data. The multiple media signals or streams can then be automatically synchronized with portable or other media viewing and listening devices or archived for later viewing and use in the format desired. No second pass conversion hardware or software is needed in the present invention.

For example, a current high performance microprocessor, known as the Cell processor, is able to process and decode up to 48 standard definition channels simultaneously. The Cell processor is available from International Business Machines Corporation, Armonk, N.Y., and is composed of a single 64-bit RISC processor and eight 32-bit microprocessor units, which are bound together by an internal bus. Each 32-bit microprocessor component is a subordinate part of the whole Cell processor, and is controlled by the 64-bit unit which handles the scheduling and parceling of data. Each 32-bit microprocessor has 256 KB of on-die memory which is addressed similar to typical system RAM. A built-in dual channel memory controller connects to 256 MB of memory. Communication with the rest of the system is provided by a bus that allows high speed, chip-to-chip communication between different Cell processors, either inside or outside the same computer system. The present invention preferably utilizes such level of processing power to generate multiple formats simultaneously for use in other ways.

As shown in the FIGURE, an otherwise conventional decoder/tuner device 22 receives a media signal 20 from a standard source, such as a video camera or microphone, an antenna, a cable television cable, or any other source of audio or video signals. The media signal input may be in analog or digital form. In the case of an antenna or cable television source, the media signal input 20 comprises a plurality of different programming channel signals. The decoded media signal, for example, one or more television or radio station channels, is then sent from the decoder/tuner 22 to a media process 24, such as the aforementioned cell processor, for simultaneous multiple stream encoding.

A user display screen 25 displays for the user the desired media signal selection parameters along with the different media formats to which the media processor 24 is able to encode the media signal. Media signal selection parameters may include the desired input device or signal, for example, a television channel or radio station, or other auxiliary device such as a video camera or video or audio recorder, along with the date and time of recording of the media signal for the desired program. Other screen options and layout can be used; however the intent is for the menu system to allow the user to identify and program the recording/conversion of the various input streams and also to select the target media format(s)/

The term “media format” refers to the input/output file format and, if needed, specific directory structure of the desired media output file(s). The different media formats available on user screen 25 may include audio/video: DivX, Mpeg, DV, and formats compatible (by screen, bitrate, and the like) with alternate media devices, for example, portable devices such as video iPod and audio devices using mp3, Wma, or Real Audio. Other additional or new formats and compression techniques may be supported by this invention. The available formats may also include those for any text extracted from close caption data stream in formats such as Microsoft Word, Html, and .txt file formats. The user screen may also include default formats that represent common audio and/or video formats for each type of input source. Another option is to perform voice recognition and convert the audio to the desired output text formats.

In operation, the user would identify on screen 25 the time, date and channel to view and/or record as well as the formats to which the media signal is to be converted. The user's selections for media signal are sent to the decoder/tuner 22 and the user's selections for media format are sent to the media processor 24.

Once the desired media signal selection parameters and different media formats are configured in the user display and received by media processor 24, the media processor commences the simultaneous decoding and conversion of the media signal into the multiple selected media formats in parallel streams. The media processor also sends the converted media signal in the different formats to storage device 28. Storage device 28 may be any conventional computer storage device, such as a semiconductor chip, a read-only memory, magnetic media such as a diskette or computer hard drive, or optical media such as a CD or DVD ROM.

In the embodiment shown in the FIGURE, the user may have selected a TV Mpeg format 26a, a portable Mpeg format 26b, a Mp3 format 26c and a text format 26d. The storage device 28 stores each of these different media signal formats in separate files that are appropriately identified for later retrieval. As a result, the user can simply access the appropriate file via an output circuit 30, and the saved file in the proper format would be automatically downloaded to a media device using that format, with no further format conversion needed. Preferably, the output circuit 30 in conjunction with the media microprocessor and transfer station would be adapted to detect automatically the type of media device that is attached to the system, or at least the audio/video format used by the media device. Alternatively, the user instructs the system of the media format to be downloaded. The media format and/or media device information is received by the system and the microprocessor subsequently downloads the proper media format to the media device.

For example, once docked to transfer station 32b or 34c, an iPod would be able to sync with the specific directories in storage device 28 that contain the iPod-compatible media formats, and it would automatically load the portable Mpg files 30b and/or the mp3 files 30c via outputs 34b and 34c, respectively. If the user desired to burn a DVD (and had specified the DVD format on the user display), the correct file structure and format would already be created on storage device 28, and one would be able to transfer the media signal in the proper DVD format 30a to the TV Mpeg decoder 32a and output the signal 34a to burn the DVD directly without further format conversion. Any text to be extracted from a closed caption stream would automatically be available from a file on storage device 28 via an already-formatted media signal 30d to be available for the user via text transfer station 32d and output 34d to include in a report, view on a web page, or access in any manner suitable for text. The originally recorded media signal may be likewise retrieved from a program file in device 28 in another stored format 30e for transfer 32e and output 34e to a media device using that format.

In a further embodiment, media processor 24 may simultaneously decode and convert multiple channels input from decoder/tuner 22 and distribute them individually to multiple TV monitors. Each viewer would request a channel and the media processor system of the present invention would simultaneously decode and rout the appropriate signal to the appropriate TV monitor, thus reducing or even eliminating the need for tuner or set top boxes at each TV monitor. Such multiple shows may also be simultaneously recorded onto storage device 28 for later viewing.

The method of the present invention for multiple stream formatting in a multimedia system comprising may be implemented by a computer program or software incorporating the process steps and instructions described above in otherwise conventional program code and stored on an otherwise conventional program storage device. As shown in the FIGURE, the program code, as well as any input information required, may be stored in a computer on storage device 28. The computer system employs microprocessor 24 for reading and executing the stored program on device 28.

Thus, the present invention provide an improved method and system for storing and viewing media signal program files in a plurality of different media formats, by formatting the media signal into multiple streams that may be used by different format media viewers. The invention enables multiple stream formatting in a multimedia system, and storage of such multiple streams for easy later viewing and listening. In particular, the invention enables retrieval of a recorded program file and download to different media player formats without converting the file from one format to another.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A method of multiple stream formatting in a multimedia system comprising:
providing an input media signal;
converting the media signal to a plurality of different media formats;
storing the converted media signal in the plurality of different media formats on a storage device;
retrieving one or more desired different formats of the media signal; and
transferring the selected format of the media signal to a media device compatible with the selected format.

2. The method of claim 1 including simultaneously converting the media signal in parallel to a plurality of different media formats prior to storing the converted media signal in the plurality of different media formats.

3. The method of claim 1 further including providing a menu of different media formats, selecting a plurality of different media formats from the menu and subsequently converting the media signal to the plurality of selected media formats.

4. The method of claim 1 wherein the media signal is converted to different audio, video or text formats.

5. The method of claim 1 wherein the media signal is converted to different media formats selected from the group consisting of DV, Divx, Mpeg, Mp3, Wma, and Real formats.

6. The method of claim 1 further including connecting a media device to the storage device, and identifying a media format used by the media device, and using the identification of the media format used by the media device to select the same media format from the storage device for retrieval and transfer of the selected format of the media signal to the media device.

7. The method of claim 1 further including using the desired format of the media signal on the media device without further format conversion.

8. The method of claim 1 further including simultaneously converting each of a plurality of media signals to a plurality of different media formats prior to storing the converted media signals in the plurality of different media formats.

9. A system for formatting one or more streams of a media signal comprising:
a media signal input circuit;
a media signal conversion processor for simultaneous parallel conversion of the media signal to plurality of different media formats;
a storage device for storing the converted media signal in the plurality of different media formats; and
a plurality of output circuits connectible to different media devices for retrieving one of the formats of the media signal compatible with a media device and transferring the compatible format of the media signal to the media device.

10. The system of claim 9 further including a menu display of different media formats into which the media signal may be converted.

11. The system of claim 9 wherein the conversion processor is adapted to convert the media signal into different audio, video or text formats.

12. The system of claim 9 wherein the conversion processor is adapted to convert the media signal into different media formats selected from the group consisting of DV, Divx, Mpeg, Mp3, Wma, and Real formats.

13. The system of claim 9 wherein the output circuit is adapted to identify the media format used by the media device to which it is connected and use the identification of the media format used by the media device to select the same media format from the storage device for retrieval and transfer of the selected format of the media signal to the media device.

14. The system of claim 9 wherein the output circuit is adapted to transfer the selected format of the media signal on the media device without further format conversion.

15. The system of claim 9 wherein the media signal conversion processor is adapted to simultaneously convert each of a plurality of media signals to a plurality of different media formats prior to the storage device storing the converted media signals in the plurality of different media formats.

16. A computer program product for use with a multimedia system for formatting one or more streams of a media signal, said computer program product comprising:
a computer usable medium having computer readable program code means embodied in said medium for converting the media signal to a plurality of different media formats;
computer readable program code means for storing the converted media signal in the plurality of different media formats on a storage device;
computer readable program code means for retrieving one or more desired different formats of the media signal; and
computer readable program code means for transferring the selected format of the media signal to a media device compatible with the selected format.

17. The computer program product of claim 16 including computer readable program code means for simultaneously converting the media signal in parallel to a plurality of different media formats prior to storing the converted media signal in the plurality of different media formats.

18. The computer program product of claim 16 including computer readable program code means for providing a menu of different media formats, selecting one or more different media formats from the menu and subsequently converting the media signal to the plurality of selected media formats.

19. The computer program product of claim 16 including computer readable program code means for transferring the desired format of the media signal on the media device without further format conversion.

20. The computer program product of claim 16 including computer readable program code means for simultaneously converting each of a plurality of media signals to a plurality of different media formats prior to storing the converted media signals in the plurality of different media formats.
